(19) United States
(12) Patent Application Publication
(10) Pub. No.: US 2007/0150765 A1
(43) Pub. Date: Jun. 28, 2007

(54) Information processing apparatus having electronic device whose operating speed is controlled, and method of controlling the operating speed of the electronic device

(76) Inventor: Takayuki Ochiai, Ome-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/638,206

(22) Filed: Dec. 13, 2006

(30) Foreign Application Priority Data
Dec. 26, 2005 (JP) 2005-373169

(51) Int. Cl. G06F 1/00

(52) U.S. Cl. 713/300

(57) ABSTRACT

A power supply circuit generates a power supply voltage. The power supply voltage is applied to an electronic device. A voltage monitoring unit monitors a power supply voltage that is applied to the electronic device, and makes a request to a bus control unit to switch the operating speed of the electronic device in accordance with the power supply voltage such that the operating speed of the electronic device becomes lower as the power supply voltage drops. The bus control nit switches the transfer speed of a bus at the request of the voltage monitoring unit to switch the operating speed of the electronic device.

### CROSS-REFERENCE TO RELATED APPLICATIONS

This application is based upon and claims the benefit of priority from Japanese Patent Application No. 2005-373169, filed Dec. 26, 2005, the entire contents of which are incorporated herein by reference.

### BACKGROUND

1. Field

One embodiment of the invention relates to an information processing apparatus having an electronic device whose operating speed is controlled, and a method of controlling the operating speed of the electronic device.

2. Description of the Related Art

It is commonly known that the transfer speed of a bus to which an input/output device, which is included in an information processing apparatus such as a personal computer, is connected has only to increase in order to increase the operating speed of the input/output device. It is also known that the frequency (core frequency) of a clock (core clock) used inside a processor (CPU) included in the information processing apparatus has only to increase in order to increase the operating speed of the processor. The core frequency will also be referred to as the core frequency of the processor (CPU) hereinafter.

It is also known that as an electronic device such as an input/output device and a processor increases in operating speed, it increases in power consumption and heat dissipation (and so does an information processing apparatus including the electronic device). For this reason, power saving or thermal control is important chiefly for a portable battery-operated information processing apparatus such as a notebook personal computer.

Recently, for example, an information processing apparatus employing the technique of varying the frequency of a clock signal or the transfer speed of a bus has been proposed for power saving or thermal control. Such an information processing apparatus is disclosed in, for example, Jpn. Pat. Appln. KOKAI Publications Nos. 2005-71365 and 2005-63293. The technique for the power saving or thermal control disclosed in the publications does not employ any power supply voltage.

It is evident that power saving or thermal control of an information processing apparatus can be achieved if a power supply voltage applied to each device of the information processing apparatus is dropped. However, the drop of the power supply voltage may make the operation of each device (namely, the operation of the entire information processing apparatus) unstable.

According to one embodiment of the invention, there is provided an information processing apparatus. The information processing apparatus comprises a power supply circuit which generates a power supply voltage, an electronic device to which the power supply voltage generated by the power supply circuit is applied, a voltage monitoring unit configured to monitor the power supply voltage applied to the electronic device and make a request to switch an operating speed of the electronic device to a lower operating speed as the power supply voltage is low, and an operating-speed control unit configured to switch the operating speed of the electronic device at the request of the voltage monitoring unit.

### BRIEF DESCRIPTION OF THE SEVERAL VIEWS OF THE DRAWINGS

A general architecture that implements various features of the invention will now be described with reference to the drawings. The drawings and their associated descriptions are provided to illustrate the embodiments of the invention and not to limit the scope of the invention.

FIG. 1 is a block diagram showing an exemplary system configuration of a battery-operated notebook personal computer according to an embodiment of the invention;

FIG. 2 is a block diagram showing an exemplary configuration of a CPU, a PCI device and a power supply circuit shown in FIG. 1 together with their peripheral circuit;

FIG. 3 is an exemplary waveform chart of a power supply voltage, illustrating a change in transfer speed made by the PCI device in the embodiment of the invention; and

FIG. 4 is an exemplary waveform chart of a power supply voltage, illustrating a change in transfer speed made by the PCI device in a modification to the embodiment of the invention.

### DETAILED DESCRIPTION

Various embodiments according to the invention will be described hereinafter with reference to the accompanying drawings. In general, according to one embodiment of the invention, there is provided an information processing apparatus. The information processing apparatus comprises a power supply circuit which generates a power supply voltage, an electronic device to which the power supply voltage generated by the power supply circuit is applied, a voltage monitoring unit configured to monitor the power supply voltage applied to the electronic device and make a request to switch an operating speed of the electronic device to a lower operating speed as the power supply voltage is low, and an operating-speed control unit configured to switch the operating speed of the electronic device at the request of the voltage monitoring unit.

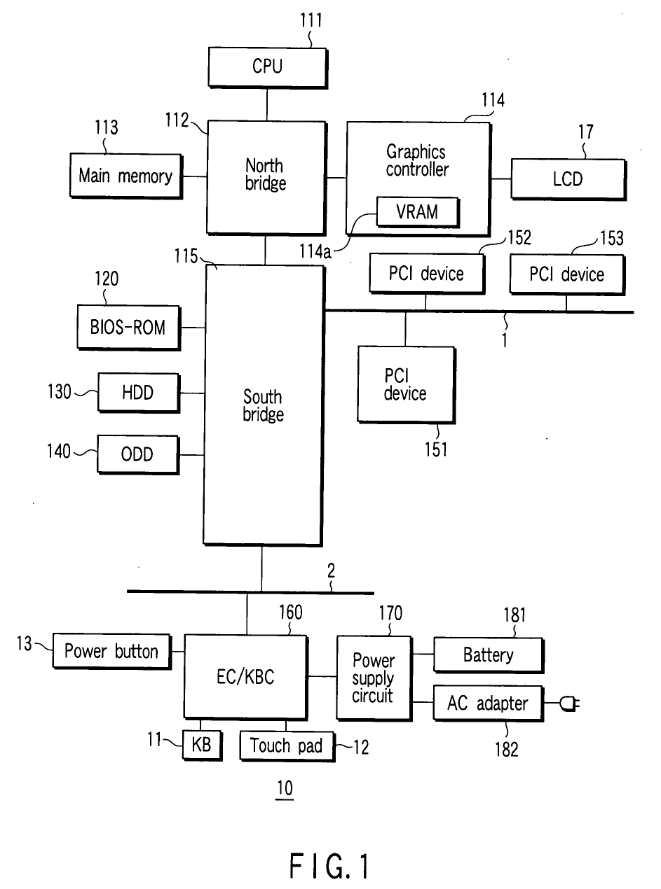

Referring first to FIG. 1, the system configuration of an information processing apparatus according to an embodiment of the invention will be described. The information processing apparatus is implemented as, for example, a battery-operated notebook personal computer 10.

As shown in FIG. 1, the computer 10 includes a CPU 111, a north bridge 112, a main memory 113, a graphics controller 114 and a south bridge 115. The computer 10 also includes a BIOS-ROM 120, a hard disk drive (HDD) 130, an optical disk drive (ODD) 140, PCI devices 151, 152 and 153, an embedded controller/keyboard controller IC (EC/KBC) 160 and a power supply circuit 170.

The CPU 111 is a processor that controls the operation of the computer 10. The CPU 111 executes an operating system (OS) that is loaded into the main memory 113 from a boot device. In the present embodiment, the HDD 130 is used as the boot device. The CPU 111 also executes various application programs and a Basic Input Output system (BIOS). The BIOS is a program for control of hardware and stored in the BIOS-ROM 120 in advance.

The north bridge 112 is a bridge device that connects the local bus of the CPU 111 and the south bridge 115. The north bridge 112 incorporates a memory controller that controls access to the main memory 113. The north bridge 112 also has a function of communicating with the graphics controller 114 via an Accelerated Graphics Port (AGP) bus and the like.

The graphics controller 114 is a display controller that controls a liquid crystal display (LCD) 17. The LCD 17 is used as a display monitor of the computer 10. The graphics controller 114 has a video memory (VRAM) 114a. The graphics controller 114 generates a video signal for forming a display image from the display data written into the VRAM 114a. The display image is to be displayed on the LCD 17.

The south bridge 115 controls access to the BIOS-ROM 120. The BIOS-ROM 120 is a rewritable nonvolatile memory such as a flash ROM. As described above, the BIOS-ROM 120 stores the BIOS. The south bridge 115 controls a disk drive (I/O device) such as the HDD 130 and the ODD 140. The south bridge 115 is connected to a Peripheral Component Interconnect (PCI) bus 1 and a Low Pin Count (LPC) bus 2. The south bridge 115 controls each device on the PCI bus 1 and LPC bus 2.

The HDD 130 is a storage device which stores various types of software and data. The HDD 130 reads/writes data from/to a magnetic recording medium (magnetic disk) through a head (magnetic head). The magnetic recording medium is rotated by a motor. The HDD 130 stores the OS in advance. The OS is loaded into the main memory 113 in accordance with the BIOS stored in the BIOS-ROM 120 and thus executed by the CPU 111.

The ODD 140 is a drive unit which rotates an optical recording medium (optical disc) such as a compact disc (CD) and a digital versatile disc (DVD) through a motor. The ODD 140 reads/writes data from/to the optical disc through a head (optical head).

The PCI devices 151, 152 and 153 are connected to the PCI bus 1. In the present embodiment, the PCI device 151 is a local area network (LAN) controller, the PCI device 152 is a wireless LAN controller and the PCI device 153 is a card controller.

The EC/KBC 160 is a microcomputer in which an embedded controller (EC) for managing a power supply and a keyboard controller (KBC) for controlling a keyboard (KB) 11 and a touch pad 12 are integrated on a single chip. The EC/KBC 160 has a power control function of operating in cooperation with the power supply circuit 170 and powering on/off the computer 10 in response to a user's depression of a power button 13. The EC/KBC 160 also controls the selection of a power supply voltage generated by the power supply circuit 170.

The power supply circuit 170 generates a power supply voltage using a direct-current (DC) voltage (first DC voltage or second DC voltage) that is applied from a rechargeable battery 181 or an AC adapter 182. The generated power supply voltage is applied to each of the electronic devices included in the computer 10. The AC adapter 182 includes an AC-DC converter that transforms a commercial AC voltage into a given DC voltage (second DC voltage).

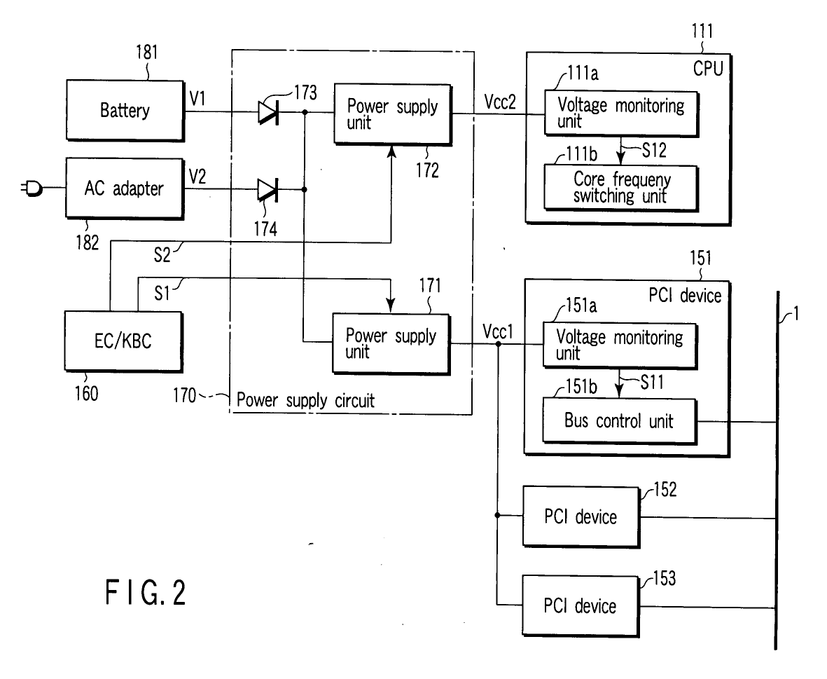

FIG. 2 is a block diagram showing a configuration of the CPU 111, PCI device 151 and power supply circuit 170 shown in FIG. 1 together with their peripheral circuit. The power supply circuit 170 includes power supply units 171 and 172 and backflow-prevention diodes 173 and 174.

The output (positive electrode) of the battery 181 is connected to the anode of the diode 173, while the output (positive electrode) of the AC adapter 182 is connected to the anode of the diode 174. The cathodes of the diodes 173 and 174 are connected to the inputs of the power supply units 171 and 172.

When no AC power supply is connected to the power supply circuit 170 (computer 10) via the AC adapter 182 (i.e., when the AC power supply is shut off), a DC voltage V1 is applied from the battery 181 to the power supply units 171 and 172 via the diode 173. On the other hand, when an AC power supply is connected to the power supply circuit 170 (computer 10) via the AC adapter 172, a DC voltage V2 is applied from the AC adapter 182 to the power supply units 171 and 172 via the diode 174. In the present embodiment, the DC voltage V1 is lower than the DC voltage V2 (V1<V2).

The power supply units 171 and 172 are DC-DC converters that convert the DC voltages applied from the battery 181 or AC adapter 182 into DC voltages (power supply voltages) Vcc1 and Vcc2, respectively. In the present embodiment, the power supply units 171 and 172 have functions of switching the level of power supply voltages Vcc1 and the level of power supply voltages Vcc2 in response to switching signals S1 and S2 output from EC/KBC 160, respectively. The voltages Vcc1 and Vcc2 each have two different levels, e.g., a high voltage and a low voltage.

The power supply voltage Vcc1 generated from the power supply unit 171 is applied to the PCI devices 151 to 153, which are connected to the PCI bus 1, as the power supply voltages of the PCI devices 151 to 153. On the other hand, the power supply voltage Vcc2 generated from the power supply unit 172 is applied to the CPU 111 as the power supply voltage of the CPU 111.

The PCI device 151 includes a voltage monitoring unit 151a and a bus control unit 151b. The voltage monitoring unit 151a monitors the level of the power supply voltage Vcc1 applied to the PCI device 151. The voltage monitoring unit 151a outputs a control signal S11 which requests the bus control unit 151b to select the transfer speed of the PCI bus 1 in accordance with the results of voltage monitoring of the voltage monitoring unit 151a.

In the present embodiment, the voltage monitoring unit 151a includes a comparator which outputs a control signal S11. The level of the control signal S11 becomes high when the power supply voltage Vcc1 drops below a reference voltage (first reference voltage) Vb, and becomes low when the power supply voltage Vcc1 rises over a reference voltage (second reference voltage) Va. The reference voltage Vb is a voltage used as a condition for a change in transfer speed from high transfer speed TS1 to low transfer speed TS2. On the other hand, the reference voltage Va is a voltage used as a condition for a change in transfer speed from low transfer speed TS2 to high transfer speed TS1. The change from the low level to the high level of the control signal S11 indicates a change to the low transfer speed TS2, while the change from the high level to the low level of the control signal S11 indicates a change to the high transfer speed TS1. The bus control unit 151b serves as an operating-speed control unit which selects the transfer speed of the PCI bus 1 in accordance with the state of the control signal S11.

The CPU 111 includes a voltage monitoring unit 111a and a core frequency switching unit 111b. The voltage monitoring unit 111a monitors the level of the power supply voltage Vcc2 applied to the CPU 111. The unit 111a outputs a control signal S12 in accordance with the result of voltage monitoring. The control signal S12 requests the core frequency switching unit 111b to switch the core frequency of the CPU 111. The core frequency of the CPU 111 means the frequency of a clock (core clock) used inside the CPU 111.

In the present embodiment, the voltage monitoring unit 111a includes a comparator which outputs the control signal S12. The level of the control signal S12 becomes high when the power supply voltage Vcc2 drops below a reference voltage Vb, and becomes low when the power supply voltage Vcc2 rises over a reference voltage Va. The reference voltage Vb is a voltage used as a condition for a change in core frequency from high frequency to low frequency. On the other hand, the reference voltage Va is a voltage used as a condition for a change in core frequency from low frequency to high frequency. The change from the low level to the high level of the control signal S12 indicates a request to change to the low frequency, while the change from the high level to the low level of the control signal S12 indicates a request to change to the high frequency. The core frequency switching unit 111b serves as an operating-speed control-unit which selects the core frequency (core frequency of the CPU 111) in accordance with the state of the control signal S12.

As described above, in the present embodiment, the reference voltages Va and Vb used in the voltage monitoring unit 151a and the reference voltages Va and Vb used in the voltage monitoring unit 111a are the same, respectively. However, the voltage monitoring units 151a and 111a may employ different reference voltages.

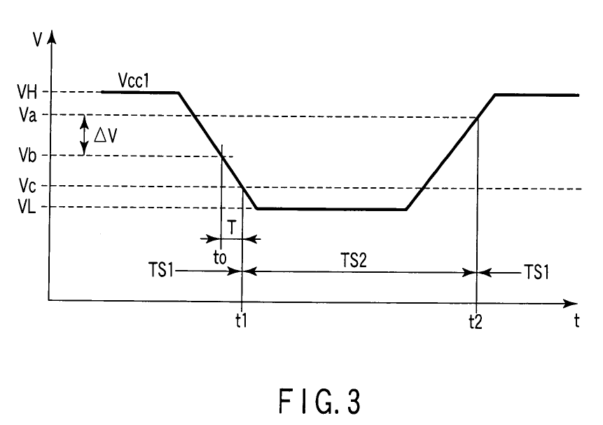

The operation of the embodiment will be described, taking a selection of the transfer speed made by the PCI device 151 as an example, with reference to the waveform chart of the power supply voltage Vcc1 shown in FIG. 3. Assume first that the power supply units 171 and 172 in the power supply circuit 170 generate high power supply voltages Vcc1 and Vcc2. Assume in this state that power saving or thermal control of the computer 10 is required. In this assumption, the EC/KBC 160 functions as a power management controller to request the power supply units 171 and 172 to generate low power supply voltages Vcc1 and Vcc2, respectively, using the switching signals S1 and S2. Then, the power supply units 171 and 172 switch the power supply voltages Vcc1 and Vcc2 to their respective low voltages of a given level.

The voltage monitoring unit 151a in the PCI device 151 monitors the power supply voltage Vcc1 that is applied to the PCI device 151. Assume now that the power supply unit 171 performs an operation to switch the power supply voltage Vcc1 from a high voltage (first voltage level) VH to a low voltage (second voltage level) VL and consequently the power supply voltage Vcc1 drops below the reference voltage Vb at time t0 shown in FIG. 3. The reference voltage Vb in the voltage monitoring unit 151a is a voltage used as a condition for switching the transfer speed from high transfer speed TS1 to low transfer speed transfer TS2, as described above.

If the power supply voltage Vcc1 drops below the reference voltage Vb at time t0, the voltage monitoring unit 151a switches the control signal S11 from a low level to a high level. If the control signal S11 is changed from a low level to a high level, the bus control unit 151b switches the transfer speed of the PCI bus 1 from high transfer speed (first transfer speed) TS1 to low transfer speed (second transfer speed) TS2.

In the voltage monitoring unit 151a, the reference voltage Vb is set higher than the lowest power supply voltage Vc capable of a stable transfer at high transfer speed TS1 on the PCI bus 1. If, therefore, the high transfer speed TS1 is changed to the low transfer speed TS2 between t0 and t1 where t1 is time at which the power supply voltage Vcc1 drops below Vc, there is no fear that the operation of the PCI device 151 will become unstable. Voltage Vc is higher than voltage VL. It is shown in FIG. 3 that the high transfer speed TS1 is changed to the low transfer speed TS2 (second operating speed) at time t1.

In the present embodiment, the reference voltage Vb is lower than the reference voltage Va. In the voltage monitoring unit 151a, the reference voltage Va is a voltage used as a condition for switching the transfer speed from the low transfer speed TS2 to the high transfer speed TS1, as described above. The voltage Vb used as a condition for switching to the low transfer speed TS2 from the high transfer speed TS1 and the voltage Va used as a condition for switching to the high transfer speed S1 from the low transfer speed TS2 are caused to differ from each other. In other words, hysteresis is given to these voltages Va and Vb. In the present embodiment, therefore, a chattering in which the transfer speed is frequently switched by a slight variation of power supply voltage Vcc1 can be prevented from occurring.

After that, the power supply voltage Vcc1 reaches a target low voltage (second voltage level) VL. In this state, data is transferred between the PCI bus 1 and PCI device 151 at low transfer speed (second transfer speed) TS2. Power consumption and heat dissipation due to this data transfer can thus be reduced. Even though the power supply voltage Vcc1 is a low voltage VL, data is transferred between the PCI bus 1 and PCI device 151 at low transfer speed TS2. Even though the power supply circuit 170 does not have any adequate current supply capacity, the PCI device 151 can be operated stably without causing a malfunction.

Assume then that power saving or thermal control of the computer 10 becomes unnecessary. In this case, the EC/KBC 160 requests the power supply unit 171 to generate a high power supply voltage Vcc1 using the switching signal S1. Then, the power supply unit 171 performs an operation to switch the power supply voltage Vcc1 to the high voltage (first voltage level) VH of a predetermined level.

Assume now that the power supply unit 171 performs an operation to switch the power supply voltage Vcc1 from the low voltage (second voltage level) VL to the high voltage (first voltage level) VH and consequently the power supply voltage Vcc1 rises over the reference voltage Va at time t2 shown in FIG. 1. Then, the voltage monitoring unit 151a switches the control signal S11 from a high level to a low level. If the control signal S11 supplied from the voltage monitoring unit 151a is changed from a high level to a low level, the bus control unit 151b switches the transfer speed of the PCI bus 1 from the low transfer speed (second transfer speed) TS2 to the high transfer speed (first transfer speed) TS1.

In the present embodiment, when the voltage monitoring unit 151a detects that the power supply voltage Vcc1 has risen over the reference voltage Va, the transfer speed of the PCI bus 1 is switched from the low transfer speed TS2 to the high transfer speed TS1. When the voltage monitoring unit 151a detects that the power supply voltage Vcc1 has dropped below the reference voltage Vb, the transfer speed of the PCI bus 1 is switched from the high transfer speed TS1 to the low transfer speed TS2. In the present embodiment, the transfer speed of the PCI bus 1 (namely, the operating speed of the PCI device 151) is not switched before the power supply voltage is switched to a target level. There is no fear that the operation of the PCI device 151 (namely, the operation of the computer 10) will become unstable by the above-described switching. Since the power supply voltage need not necessarily be switched at high speed, an expensive, high-performance power supply circuit need not be used as the power supply circuit 170.

In the CPU 111, the core frequency of the CPU 111 is switched by the same operation as that of the PCI device 151 in accordance with the power supply voltage Vcc2 applied to the CPU 111. If the core frequency is switched, the operating speed of the CPU 111 (the operating speed of the computer 10) is switched. The switching of the core frequency in the CPU 111 will be described below.

Assume now that the power supply unit 172 performs an operation to switch the power supply voltage Vcc2 from the high voltage (first voltage level) VH to the low voltage (second voltage level) VL in response to the switching signal S2 supplied from the EC/KBC 160 for power saving or thermal control of the computer 10. Assume that the power supply voltage Vcc2 drops below the reference voltage Vb as a result.

If the power supply voltage Vcc2 drops below the reference voltage Vb, the voltage monitoring unit 111a in the CPU 111 switches the control signal S12 from a low level to a high level. If the control signal S12 supplied from the voltage monitoring unit 111a is changed from a low level to a high level, the core frequency switching unit 111b switches the core frequency from the high frequency (first core frequency) F1 to the low frequency (second core frequency) F2.

In the voltage monitoring unit 111a, when the core frequency is a high frequency (first core frequency) F1, the reference voltage Vb is set higher than the lowest power supply voltage Vc (Vc>VL) at which the CPU 111 can be operated with stability. If, therefore, the core frequency is switched from the high frequency F1 to the low frequency wave F2 during which period the power supply voltage Vcc2 drops from Vb to Vc, there is no fear that the CPU 111 will operate unstably.

The reference voltage Vb is lower than the reference voltage Va even in the voltage monitoring unit 111a as in the voltage monitoring unit 151a in the PCI device 151. In other words, in the CPU 111, hysteresis is given to the voltage which is switched from the high frequency F1 to the low frequency F2 and the voltage which is switched from the low frequency F2 to the high frequency F1. In the present embodiment, therefore, a chattering in which the core frequency is frequently switched with a slight variation of the power supply voltage Vcc2 can be prevented from occurring.

The PCI devices 152 and 153 may have the same structure as that of the PCI device 151. Though omitted in FIG. 2, the south bridge 115 connected to the PCI bus 1 in FIG. 1 may have the same structure as that of the PCI device 151. Furthermore, the device connected to a bus such as a universal serial bus (USB) other than the PCI bus 1 may have the same structure as that of the PCI device 151.

The voltage monitoring unit 111a or core frequency switching unit 111b can be provided outside the CPU 111. Similarly, the voltage monitoring unit 151a or bus control unit 151b can be provided outside the PCI device 151.

[Modification]

The above embodiment is based on the premise that there are two transfer speeds of high transfer speed (first transfer speed) TS1 and low transfer speed (second transfer speed) TS2 and there are two core frequencies of high frequency (first core frequency) F1 and low frequency (second core frequency). However, three or more transfer speeds can be used and so can be three or more core frequencies. A modification to the above embodiment having three transfer speeds and three core frequencies will be described below.

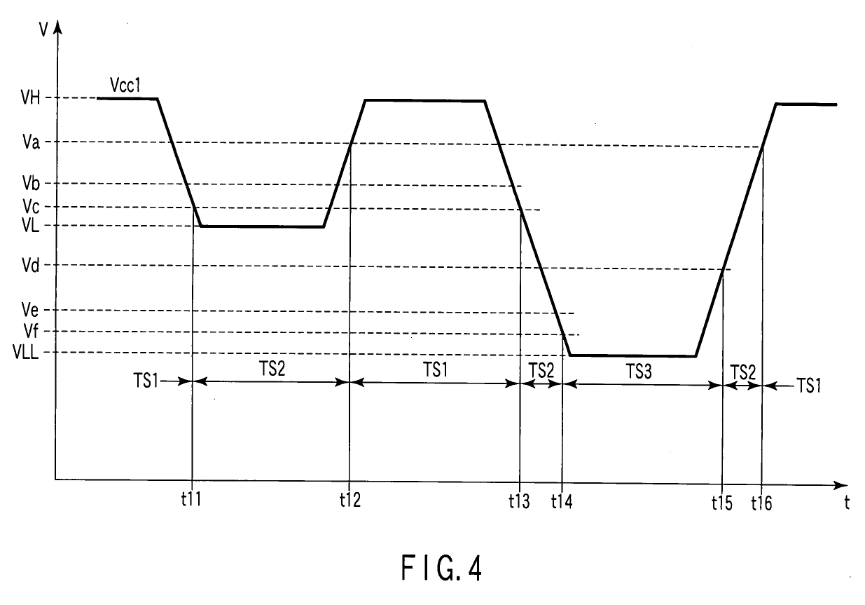

First, the switching of transfer speed made by the PCI device 151 in the modification will be described, taking three transfer speeds TS1, TS2 and TS3 as an example, with reference to the waveform chart of the power supply voltage Vcc1 shown in FIG. 4. For the sake of convenience, FIG. 2 is used to describe the modification.

Assume in the modification that the power supply voltage Vcc1 (Vcc2) has three different levels: a first voltage level VH, a second voltage level VL and a third voltage level VLL. As is apparent from FIG. 4, the relationship in size among the voltage levels is VH>VL>VLL. The operation performed when the power supply voltage Vcc1 is changed from VH to VL or from VL to VH is the same as that of the above embodiment.

If the power supply unit 171 performs an operation to switch the level of the power supply voltage Vcc1 from VH to VL, the power supply voltage Vcc1 drops below Vb and also drops below Vc at time t11. In the PCI device 151, the transfer speed of the PCI bus 1 is switched from the first transfer speed TS1 to the second transfer speed TS2 during a period from time at which the power supply voltage Vcc1 lowers to Vb to time t11. FIG. 4 shows the transfer speed of the PCI bus 1 that is switched to the second transfer speed TS2 at time t11.

After that, the power supply voltage Vcc1 reaches VL. It is then assumed that the power supply unit 171 changes the level of the power supply voltage Vcc1 from VL to VH and consequently the power supply voltage Vcc1 rises over Va at time t12. In the PCI device 151, the transfer speed of the PCI bus 1 is switched from the second transfer speed TS2 to the first transfer speed TS1 at time t12.

It is then assumed that the power supply unit 171 performs an operation to switch the level of the power supply voltage Vcc1 from VH to VLL. The PCI device 151 performs an operation to switch the transfer speed of the PCI bus 1 from the first transfer speed TS1 to the second transfer speed TS2 at the time when the power supply voltage Vcc1 drops below Vb. Thus, the transfer speed of the PCI bus 1 is switched from the first transfer speed TS1 to the second transfer speed TS2 before or on time t13 at which the power supply voltage Vcc1 drops to Vc that is lower than Vb. FIG. 4 shows a state in which the transfer speed is switched to the second transfer speed TS2 at time t13.

Assume here that the power supply voltage Vcc1 drops further to Ve that is lower than Vc. Ve (reference voltage) is a voltage used as a condition for switching the transfer speed from the second transfer speed TS2 to the third transfer speed T3 that is lower than TS2. Ve is set higher than the lowest power supply voltage Vf at which the operation can stably be performed at the second transfer speed TS2. Ve is lower than Vd (reference voltage) used as a condition for switching the transfer speed from the third transfer speed TS3 to the second transfer speed TS2.

If the power supply voltage Vcc1 drops below Ve, the voltage monitoring unit 151a in the PCI device 151 requests the bus control unit 151b to switch the transfer speed from the second transfer speed TS2 to the third transfer speed TS3. Then, the bus control unit 151b performs an operation to switch the transfer speed of the PCI bus 1 from the second transfer speed TS2 to the third transfer speed TS3. In this case, the transfer speed is switched to the third transfer speed TS3 before or on time t14 at which the power supply voltage Vcc1 drops to Vf. FIG. 4 shows a state in which the transfer speed is switched to the third transfer speed TS3 at time t14.

After that, the power supply voltage Vcc1 reaches a target voltage (third voltage level) VLL. It is then assumed that the computer 10 requires neither power saving nor thermal control. In this case, the EC/KBC 160 requests the power supply unit 171 in the power circuit 17 to generate a power supply voltage Vcc1 of the first voltage level VH. Then, the power supply unit 171 performs an operation to switch the level of the power supply voltage Vcc1 from the third voltage level VLL to the first voltage level VH.

Assume that the power supply unit 171 performs an operation to switch the power supply voltage Vcc1 from the third voltage level VLL to the first voltage level VH and consequently the power supply voltage rises over Vd at time t15 shown in FIG. 4. In this case, the voltage monitoring unit 151a requests the bus control unit 151b to switch the transfer speed of the PCI bus 1 from the third transfer speed TS3 to the second transfer speed TS2. In response to the request from the voltage monitoring unit 151a, the bus control unit 151b switches the transfer speed of the PCI bus 1 from the third transfer speed TS3 to the second transfer speed TS2 that is higher than the third transfer speed TS3.

Assume here that the power supply voltage Vcc1 rises further and exceeds Va. If the level of the power supply voltage Vcc1 exceeds Va, the voltage monitoring unit 151a requests the bus control unit 151b to switch the transfer speed of the PCI bus 1 from the second transfer speed TS2 to the first transfer speed TS1. Then, the bus control unit 151b switches the transfer speed of the PCI bus 1 from the second transfer speed TS2 to the first transfer speed TS1. After that, the power supply voltage Vcc1 reaches the target voltage (first voltage level) VH.

In the CPU 111, too, the core frequency is switched in accordance with the power supply voltage Vcc2 that is applied to the CPU 111 as in the above-described PCI device 151. Assume here that the power supply unit 172 switches the power supply voltage Vcc2 to any one of the first voltage level VH, second voltage level VL and third voltage level VLL. Thus, the CPU 111 performs an operation to switch to the core frequency corresponding to the voltage level of the power supply voltage Vcc2.

In the foregoing embodiment and modification, the level of each of the power supply voltages Vcc1 and Vcc2, which are generated by the power supply units 171 and 172, respectively, is switched for power saving or thermal control. This switching is performed under the control of the EC/KBC 160. However, the control of the EC/KBC 160 is not necessarily required only for power saving, as will be described below.

As described above, a DC voltage V1 is applied to the power supply units 171 and 172 of the power supply circuit 170 from the battery 181 while no AC power supply is connected to the power supply circuit 170 (computer 10) through the AC/DC adaptor 172. This state is called a battery-operated state. In contrast, a DC voltage V2 is applied to the power supply units 171 and 172 from the AC adapter 182 while an AC power supply is connected to the power supply circuit 170 (computer 10) through the AC/DC adaptor 172. This state is called an AC-operated state. The output voltage V1 of the battery 181 and the output voltage V2 of the AC/DC adapter differ in level from each other, and a relationship between them is V1<V2. Power saving is important especially for the battery-operated state.

The above will be satisfied if the power supply units 171 and 172 have the following first and second power supply voltage generation functions, respectively. In the first power supply voltage generation function, the power supply units 171 and 172 generate their respective power supply voltages Vcc1 and Vcc2 whose levels correspond to (for example, whose levels are proportional to) the level of the voltage V2 of the AC adapter, from the voltage V2, in the AC-operated state. In the second power supply voltage generation function, the power supply units 171 and 172 generate their respective power supply voltages Vcc1 and Vcc2 whose levels correspond to (for example, whose levels are proportional to) the level of the voltage V1 of the battery 181, from the voltage V1, in the battery-operated state.

As described above, the power supply units 171 and 172 are configured to generate their respective power supply voltages Vcc1 and Vcc2 whose levels depend on the voltages input to the units 171 and 172; therefore, the levels of the power supply voltages Vcc1 and Vcc2 can automatically be switched to each other between the battery-operated state and the AC-operated state. In the battery-operated state, the transfer speed of the PCI bus 1 and the clock (core clock) of the CPU 11 are automatically switched to the low transfer speed and the low core frequency (i.e., a low operating speed), respectively. The power consumption of the PCI device and CPU 11 can thus be reduced and, in other words, the speed of the computer 10 is switched to the low operating speed and the power consumption thereof can be reduced. Moreover, the switching to the low transfer speed and low core frequency allows the PCI device and CPU 11 (computer 10) to be operated at low voltages and with stability.

As described above, the EC/KBC 160 needs to control the power supply units 171 and 172 for power saving or thermal control. However, the control is unnecessary only for not being influenced by a variation in power supply voltage to stabilize an operation. The power supply units 171 and 172 need not be configured to generate their respective power supply voltages Vcc1 and Vcc2 whose levels depend on the voltages input to the units 171 and 172.

While certain embodiments of the inventions have been described and these embodiments have been presented by way of example only, and are not intended to limit the scope of the inventions. Indeed, the novel apparatuses and methods described herein may be embodied in a variety of other forms; furthermore, various omissions, substitutions and changes in the form of the apparatuses and methods described herein may be made without departing from spirit of the inventions. The accompanying claims and their equivalents are intended to cover such forms or modifications as would fall within the scope and spirit of the inventions.

What is claimed is:

1. An information processing apparatus comprising:
a power supply circuit which generates a power supply voltage;
an electronic device to which the power supply voltage generated by the power supply circuit is applied;
a voltage monitoring unit configured to monitor the power supply voltage applied to the electronic device and make a request to switch an operating speed of the electronic device to a lower operating speed as the power supply voltage is low; and
an operating-speed control unit configured to switch the operating speed of the electronic device at the request of the voltage monitoring unit.

2. The information processing apparatus according to claim 1, wherein the electronic device includes the voltage monitoring unit and the operating-speed control unit.

3. The information processing apparatus according to claim 1, wherein the voltage monitoring unit requests the operating-speed control unit to switch the operating speed of the electronic device from a first operating speed to a second operating speed that is lower than the first operating speed upon detecting that the power supply voltage drops below a first reference voltage, and requests the operating-speed control unit to switch the operating speed of the electronic device from the second operating speed to the first operating speed upon detecting that the power supply voltage rises over a second reference voltage that is higher than the first reference voltage.

4. The information processing apparatus according to claim 3, further comprising a power management controller configured to make a request to the power supply circuit to switch the power supply voltage,
wherein the power supply circuit switches the power supply voltage at the request of the power management controller.

5. The information processing apparatus according to claim 4, wherein the power supply circuit switches the power supply voltage from a first voltage that is higher than the second reference voltage to a second voltage that is lower than the first reference voltage when the request of the power management controller is a first request, and switches the power supply voltage from the second voltage to the first voltage when the request of the power management controller is a second request.

6. The information processing apparatus according to claim 5, further comprising:
a battery which applies a first DC voltage to the power supply circuit; and
an adapter configured to generate a second DC voltage from an AC power supply and apply the second DC voltage to the power supply circuit,
wherein:
the power supply circuit generates the power supply voltage from the second DC voltage under normal conditions, and generates the power supply voltage from the first DC voltage when the AC power supply is shut off; and
the power management controller makes the first request to the power supply circuit when the AC power supply is shut off, and makes the second request to the power supply circuit when the AC power supply is restored from the shutoff.

7. The information processing apparatus according to claim 1, further comprising:
a battery which applies a first DC voltage to the power supply circuit; and
an adapter configured to generate a second DC voltage that is higher than the first DC voltage, from an AC power supply and apply the second DC voltage to the power supply circuit,
wherein the power supply circuit generates the power supply voltage corresponding to the second DC voltage, from the second DC voltage under normal conditions, and generates the power supply voltage corresponding to the first DC voltage, from the first DC voltage when the AC power supply is shut off.

8. The information processing apparatus according to claim 1, wherein:
the electronic device is connected to a bus; and
the operating-speed control unit is a bus control unit configured to switch the operating speed by switching a transfer speed of the bus.

9. The information processing apparatus according to claim 1, wherein:
the electronic device is a processor; and
the operating-speed control unit is a core frequency switching unit configured to switch the operating speed by switching a core frequency of the processor.

10. A method of controlling an operating speed of an electronic device included in an information processing apparatus, a power supply voltage that is generated by a power supply circuit being applied to the electronic device, the method comprising:
monitoring the power supply voltage that is applied to the electronic device; and
switching the operating speed of the electronic device such that the operating speed becomes lower as the power supply voltage drops, in accordance with a result of monitoring of the power supply voltage.

11. The method according to claim 10, wherein:
the monitoring includes detecting a first state in which the power supply voltage drops below a first reference voltage and a second state in which the power supply voltage rises over a second reference voltage, the second reference voltage being higher than the first reference voltage; and
the switching includes switching the operating speed from a first operating speed to a second operating speed that is lower than the first operating speed in accordance with a detection of the first state and switching the operating speed from the second operating speed to the first operating speed in accordance with a detection of the second state.

12. The method according to claim 10, wherein:
the electronic device is connected to a bus; and
the operating speed is switched by switching a transfer speed of the bus.

13. The method according to claim 10, wherein:
the electronic device is a processor; and
the operating speed is switched by switching a core frequency of the processor.
